(19) United States
(12) Patent Application Publication
(10) Pub. No.: US 2012/0103878 A1
(43) Pub. Date: May 3, 2012

(54) SORTING INSTALLATION WITH A PLURALITY OF HOLDING APPARATUSES

(75) Inventor: PETER BERDELLE-HILGE, KONSTANZ (DE)

(73) Assignee: SIEMENS AKTIENGESELLSCHAFT, MUENCHEN (DE)

(21) Appl. No.: 13/285,394

(22) Filed: Oct. 31, 2011

(30) Foreign Application Priority Data
Oct. 29, 2010 (DE) 10 2010 043 133.8
Oct. 29, 2010 (DE) 10 2010 043 155.9
Jul. 8, 2011 (DE) 10 2011 078 902.2
Jul. 8, 2011 (DE) 10 2011 078 903.0

(51) Int. Cl. B07C 5/00

(52) U.S. Cl. 209/509

(57) ABSTRACT

A sorting installation and a sorting method sort articles, in particular flat mail items, via a plurality of holding apparatuses on the basis of a prescribed sorting feature. The sorting installation contains a plurality of sorting outputs, a loading station and a plurality of holding apparatuses. Each holding apparatus contains two side surfaces, and therefore an article can be placed between the two side surfaces. A respective recess is let into each side surface, and therefore the holding apparatus has a continuous opening. Two grippers can grip an article in the holding apparatus from both sides through the opening. For each article, it is measured what value the sorting feature assumes for the article. The article is put into a holding apparatus. The holding apparatuses with the articles are sorted. The article is removed again from the holding apparatus by the grippers.

### CROSS-REFERENCE TO RELATED APPLICATION

This application claims the priority, under 35 U.S.C. §119, of German applications Nos. DE 10 2010 043 133.8, filed Oct. 29, 2010, DE 10 2010 043 155.9, filed Oct. 29, 2010, DE 10 2011 078 902.2, filed Jul. 8, 2011 and DE 10 2011 078 903.0, filed Jul. 8, 2011; the prior applications are herewith incorporated by reference in their entireties.

### BACKGROUND OF THE INVENTION

### Field of the Invention

The invention relates to a sorting installation and to a sorting method for sorting articles, in particular flat mail items, by a plurality of holding apparatuses on the basis of a prescribed sorting feature.

Various methods have been proposed for sorting mail items by each mail item being put in a respective holding apparatus, the filled holding apparatuses being sorted and the mail items subsequently being removed again from the holding apparatuses. Sorting installations and sorting methods for rapidly and reliably removing mail items again from the sorted holding apparatuses are desired. International patent disclosure WO 2009/035694 A1 describes a sorting installation for flat mail items. Each mail item is transported in a dedicated holding apparatus (“frame”). Various refinements for extracting a mail item again from a holding apparatus of this type (“frame F”) are described.

In a refinement of international patent disclosure WO 2009/035694 A1, a “rotatable shuttle 1011” removes mail items (“mail pieces M”) from holding apparatuses (“frames F”), see FIG. 10B to FIG. 10D and paragraph [0639]. Owing to gravity, the mail items M drop out of the holding apparatuses F and land between “separation paddles 1015”, see paragraph [0643]. In another refinement, “articulating pushers 1021” reach into opened holding apparatuses F and push the mail items M out of said holding apparatuses F and toward “articulating robotic grippers 1023a and 1023b”, see FIG. 10E to FIG. 10G and paragraph [0652]. The “pushers 1021” have hooks at the front. The “grippers 1023a, 1023b” are in the form of forks.

A “shuttle 1031” transports “frames F” containing mail items M continuously in one direction, see FIG. 10H and paragraph [0656]. An endless conveyor belt 1032 moves “extractor frames EF” on a closed track, see paragraph [0657]. Each “extractor frame EF” acts on a mail item M in a “frame F” and pushes the mail item out of the “frame F”, see paragraph [0660]. If the mail item M has been pushed sufficiently far out of the “frame F”, a “gripper 1033” or a “vacuum head 1034” grips the mail item M. The removed mail items are stacked in a container. At the point RAD1, the “extractor frames EF” and the “frames F” are further transported in different directions, see paragraph [0664].

In a refinement of international patent disclosure WO 2009/035694 A1, a “frame 11115” is connected to a “folder 11116” and has four hook-shaped “actuation tabs 11118” and “11119” at the corners, see FIG. 11J and paragraph [0749]. The “folder 11116” has two side surfaces (“front membrane 11116a, back membrane 11116b”) which are mechanically connected to each other. In order to open the “folder 11116”, the “actuation tabs 11118, 11119” are rotated from a vertical, closed position into a horizontal, open position and the side surfaces 11116a, 11116b move apart, see paragraph [0752]. A C-shaped recess 11121 is let into the “front membrane 11116a”, see FIG. 11J and paragraph [0752]. A “vacuum pick-head” grips a mail item M in the “folder 11116” through the recess 111121, see paragraph [0752]. In another refinement, a C-shaped recess is also let into the “back membrane 11116”. A plurality of “frames 11115” is transported past a stationary “vacuum pick-head”, and the one “pick-head” grips the mail items M in the holding apparatuses through the C-shaped recesses, see paragraph [0753].

In the refinement of FIG. 11Q from WO 2009/035694 A1, a mail item is pushed laterally into a holding apparatus and is removed laterally again from the holding apparatus, see paragraph [0795]. The rectangular “frame 11205” has four “tabs 11207, 11208” at the four corners. A “sub-frame 11206” is fastened movably at the top to the “frame 11205” by two elongated “hinges 11213” and by two elongate “hinges 11214”, see paragraph [0799]. The holding apparatus is open on two sides. An “end-effector” can grip and move a mail item in the holding apparatus from the outside through a “cutout 11205”, see paragraph [0800]. The “end-effector” is, for example, a “vacuum pick-off head” or acts by friction, cf. paragraph [0800]. Various positions are suitable for the “cutout 11215”, see paragraph [0801]. The holding apparatus can be unfolded, for example, with “actuator tabs”, see paragraph [0802].

Published, non-prosecuted German patent application DE 10212086 A1 describes a sorting installation for pre-sorting flat mail items. Two transporting devices 3, 4 operating in parallel each transport a stream of mail items along two parallel transport paths 1, 2 toward a loading device. A plurality of storage cells 5 are transported at a constant speed and each receive an upright mail item 8, see FIG. 1. A transporting device 6, 7 unloads the storage cells 5 again. Each storage cell 5 has two side surfaces with parallel webs 10 on the inside and with a respective slot 11, see FIG. 2. A ram 12 of the unloaded transporting device 6, 7 pushes a mail item laterally out of the storage cell 5 in a horizontal direction and parallel to the side surfaces. Owing to the two parallel slots 11, the ram 12 can engage in the storage cell 5. An arrangement with two conveyor belts (“cover belt system 13”) clamps the mail item 8 and transports the latter away after the ram 12 has pushed the mail item 8 out of the storage cell 5.

U.S. Pat. No. 7,629,552 B2 describes a sorting installation for flat mail items with a multiplicity of holding apparatuses (“holders”, “escorts”). Each holding apparatus has two side surfaces (“side surfaces 100a, 100b”), an upper connecting surface (“top surface 100c”) and a base (“bottom 110”). The base 110 and the upper connecting surface 110c are connected rotatably to the side surfaces 100a, 100b, specifically by a plurality of hinges (“hinges 102, 104, 106, 108”, see FIG. 2). The hinge 108 between the base 110 and the side surface 100a can be released such that the base 110 can be folded away. The holding apparatus hangs on at least one hook (“hanger 222”). A flat mail item is pushed in a vertical position laterally between the two side surfaces. The base 110 and the upper connecting surface 100c are situated vertically here on the two side surfaces. The holding apparatus is subsequently folded together with the mail item, and therefore the two side surfaces 100a, 100b bear against the mail item and the holding apparatus has a cross section in the form of a parallelogram. In order to remove the mail item, the holding apparatus is unfolded again. The mail items are transported and sorted in the holding apparatuses.

German patent DE 19624968 C1 discloses a temporary store for flat mail items. A temporary store (container 5) of this type holds a mail item between two parallel, rectangular side walls which stand on a holder and are open laterally and upward, see FIG. 2. The holder runs on rails by a plurality of running rollers 1 and is arranged in such a manner that the side walls are transported transversely with respect to the transporting direction, see FIG. 1. In order to unload a container 5 of this type, a suction head unloader engages in the container 5 through the recesses in the side walls and transports the article away, see column 3, lines 37-41.

U.S. Pat. No. 4,169,529 describes an “item transport apparatus”, for example, for flat mail items. Each article (“item”, “document 14”) is transported in a “carrier 10”. The “carrier 10” hangs on a “transport means belt 26” by a hook-shaped “slotted hanger-like element 24”, see FIG. 1, FIG. 2, FIG. 4 and FIG. 5. The hook-shaped element 24 is connected to a planar “side member 16”. The “side member 16”, a further planar “side member 18”, an “upper support section 20” and a “lower support section 22” enclose a space from four sides, the space being open to the remaining two sides. The enclosed space is capable of receiving a “document 14”, see FIG. 1. Two openings 34, 34′ are let into the side surfaces 16, 18. The two side surfaces 16, 18 are connected to the base 22 by two “hinged couplings along lines 32, 32′”, see FIG. 2. The two side surfaces 16, 18 are correspondingly connected to the roof 20 by two “hinged couplings along lines 30, 30′”. As a result, the “carrier 10” can be folded up, see FIG. 4, and unfolded again, see FIG. 1 and FIG. 2. A “carrier 10” which is empty and is folded up is transported away via two rising conveyor belts (“drive pulleys 46, 46′”), and thereby raised and unfolded, see FIG. 6. A “document insertion belt 48” pushes an article 14 in the direction of the arrow 15 into the unfolded “carrier 10”. The filled “carrier 10” is transported further and is then no longer supported, as a result of which gravity folds up the filled “carrier 10” again. For unloading, the folded up “carrier 10” is transported away via two “carrier unloading opener belts 54” and thereby unfolded again. A “moving vacuum remover belt 56” grips the article 14 in the unfolded “carrier 10” through the recesses 34, 34′ and pulls the article 14 out of the “carrier 10”.

### SUMMARY OF THE INVENTION

It is accordingly an object of the invention to provide a sorting installation with a plurality of holding apparatuses which overcome the above-mentioned disadvantages of the prior art methods and devices of this general type, which are capable of sorting a plurality of articles by the articles being put into holding apparatuses, the filled holding apparatuses being sorted and the articles being removed again from the sorted holding apparatuses. Wherein it is intended to reduce the risk of an article dropping out of a holding apparatus or being damaged upon removal from a holding apparatus, and it is nevertheless intended to enable rapid unloading of the holding apparatuses.

The sorting installation according to the solution and the sorting method according to the solution enable articles to be sorted on the basis of a prescribed sorting feature.

The sorting installation used includes the following components:

at least one loading station,
a measuring instrument which is capable of measuring the sorting feature,
a sorting and transporting device,
a plurality of holding apparatuses, and
at least one unloading station.

Each holding apparatus contains two mutually parallel side surfaces. These side surfaces enclose a space. An article to be sorted can be put into this space and removed again from this space.

The loading station is configured for the purpose of placing articles to be sorted into holding apparatuses.

The sorting and transporting device is capable of transporting a holding apparatus together with an article, which is located in this space between the side surfaces, to the unloading station. Furthermore, the sorting and transporting device is capable of sorting the holding apparatuses together with the articles in the holding apparatuses.

The unloading station is configured for the purpose of removing the articles which are held in each case and are to be sorted from filled holding apparatuses. The unloading station contains a gripping apparatus with two grippers. The gripping apparatus is capable of changing the distance between the grippers and of thereby gripping an article with the two grippers.

At least one holding apparatus is configured as now described. A respective recess is let into each side surface of the holding apparatus such that the holding apparatus has a total of two recesses. The two side surfaces are arranged in such a manner that each side surface has a respective recess region. This recess region in a side surface is identical to the recess in said side surface or identical to a subregion of the recess. The two recess regions form a continuous opening which, as seen in a viewing direction perpendicular to the side surface, is formed in the two parallel side surfaces. The continuous opening is adjacent to in each case one edge of each side surface and thereby interrupts the edge. These two edges of the two side surfaces are adjacent edges of the side surfaces.

It is possible for a plurality of, or even for all of, the holding apparatuses to each have two recess regions of this type and therefore also to have a continuous opening.

The now described steps are carried out for each article to be sorted. The measuring instrument measures what value the prescribed sorting feature assumes for this article. The loading station puts the article into a holding apparatus such that, after being put in, the article is located in the space between the two side surfaces of the holding apparatus. The holding apparatus holds the article after the latter has been put in.

The sorting and transporting device transports the holding apparatus together with the held article to an unloading station. During this transport, the article is located in the space between the two side surfaces and is held by the holding apparatus.

The gripping apparatus of the unloading station removes the article from the holding apparatus.

In this case, the two grippers of the gripping apparatus grip the article in the holding apparatus through the two recesses in the two side surfaces of the holding apparatus and firmly hold the article. A relative movement of the two grippers relative to the gripping apparatus is carried out. The article is pulled out of the holding apparatus.

The sorting and transporting device sorts the articles when the articles are in the holding apparatuses. For this purpose, the sorting and transporting device sorts the filled holding apparatuses, specifically depending on the measured sorting feature values of the articles in said holding apparatuses.

The article is held by the holding apparatus throughout the transport from the loading station to the selected sorting output. This makes it possible to transport the article in a space-saving manner. In particular, it is possible to transport the article in such a manner that the article plane, in which the article extends, is arranged perpendicularly or obliquely to the respective transporting direction. This effect cannot be obtained if the article were to be transported without a holding apparatus merely by conveyor belts of a transporting device.

Since a respective recess is let into both side surfaces of the holding apparatus and since the two recesses form a continuous opening which begins at opposite edges, an article can easily be pulled out of the holding apparatus without the article being damaged and without the holding apparatus having to be held in a complicated manner.

A gripping apparatus can reach toward the article from both sides by two grippers, for example by two rollers, and can securely and firmly hold the article between the two grippers. The force of one gripper is transported to the other gripper in each case. The force exerted by a gripper is prevented from bending or crumpling or bending the article and, in the process, damaging or soiling the latter. The effect cannot be obtained by a handling unit which acts only from one side.

The gripping apparatus is capable of changing the distance between the grippers. As a result, the same gripping apparatus is capable of removing articles of differing thickness from a holding apparatus, or of not exerting too high or too low a force on an article.

The holding apparatus merely needs to be locked against pivoting in the direction in which the gripping apparatus pulls the article out of the holding apparatus, so that a relative movement of the grasped article relative to the holding apparatus is made possible. It is not necessary to lock the holding apparatus against rotation or pivoting in another direction, in particular not in a direction in which a gripper is moved during the gripping movement.

According to the solution, the sorting installation has an unloading station with a gripping apparatus of this type. The gripping apparatus contains two grippers. The unloading station removes an article from the holding apparatus after the holding apparatus containing the article has reached the selected sorting output. The holding apparatus and the two grippers of the gripping apparatus are positioned in such a manner that the two grippers are capable of reaching through the two congruent recess regions in the two side surfaces of the holding apparatus. The two grippers grip the article from both sides through the recesses and use the continuous opening. The two grippers or the holding apparatus or all three are moved, and the article is pulled out of the holding apparatus, specifically by a relative movement of the grippers, which hold the article between them, relative to the holding apparatus.

The two recesses are preferably let into the two side surfaces in such a manner that each recess is adjacent to an edge of the side surface, which edge is not connected to the corresponding, opposite edge of the other side surface. On the contrary, the holding apparatus at the boundary edge has a continuous slot between the edges of the side surfaces, and the article can be pulled out of the holding apparatus through said slot.

However, it is also possible for the two side surfaces to be temporarily connected to one another at all of the mutually corresponding edges during the transport of the holding apparatus together with an article. Only when the article is to be pulled out of the holding apparatus are the edges, which are adjoined by the continuous opening, separated from one another beforehand.

The gripping apparatus preferably has a force-limiting device. The force limitation has the effect that the grippers exert only a predefined maximum force on a grasped article, no matter how thick the article in the holding apparatus is. This further reduces the risk of the grasped article being damaged during unloading.

Each holding apparatus preferably has a respective recess in the two side surfaces. The gripping apparatus is thereby capable of unloading all of the holding apparatuses in the same manner. However, it is also possible for the sorting installation to grasp holding apparatuses with recesses and holding apparatuses which are unloaded in a different manner.

The sorting installation is preferably used in order to sort flat articles, each article to be sorted extending in an article plane. Each holding apparatus is preferably positioned in such a manner that, during the transport, the two side surfaces and the article plane of an article are oriented perpendicularly in the holding apparatus. Little space, as seen in the transport direction, is thereby required.

In one refinement, the sorting installation has a plurality of sorting outputs. For each holding apparatus with an article, a sorting output is selected, specifically depending on the measured sorting feature value of the article in said holding apparatus. The holding apparatuses with the article are transported to the selected sorting output. In a development of this refinement, a plurality of sorting passes are passed through in succession because there are more possible sorting feature values than sorting outputs of the sorting installation. In this refinement, each article is placed into a holding apparatus by the loading station during the first sorting pass and remains in the holding apparatus at least until the final sorting pass has finished. Preferably, the articles to be sorted remain in the respective holding apparatus between two successive sorting passes.

In another refinement, an order among the occurring sorting feature values is prescribed. The filled holding apparatuses are placed in a sequence—or a plurality of subsets of filled holding apparatus are placed into a respective sequence. The arrangement of the filled holding apparatuses in the sequence or in the sequences corresponds to the prescribed order of the sorting feature values.

Other features which are considered as characteristic for the invention are set forth in the appended claims.

Although the invention is illustrated and described herein as embodied in a sorting installation with a plurality of holding apparatuses, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a sorting installation with a plurality of holding apparatuses according to the invention;

FIG. 2 is a diagrammatic, side, perspective view of the holding apparatus with a centrally mounted coupling element and two recesses;

FIG. 3 is an illustration showing the holding apparatus of a centrally mounted coupling element in front view with a thin mail item;

FIG. 4 is an illustration showing the holding apparatus from FIG. 3 with a thick mail item instead of a thin one;

FIG. 5 is an illustration showing the holding apparatus with two concavely bent side surfaces in a front view;

FIG. 6 is a diagrammatic, side view of the holding apparatus with two lateral coupling elements and two recesses; and

FIG. 7 is an illustration showing a continuous opening which is formed by two recesses.

### DETAILED DESCRIPTION OF THE INVENTION

In the exemplary embodiment, the invention is used to transport flat mail items within a sorting installation. Each mail item to be sorted is provided with an identifier of a destination to which the mail item is to be transported. Each flat mail item extends in a respective article plane.

The sorting installation in the exemplary embodiment has:

a feeder for mail items together with a singulator,
a reader for destination addresses,
at least one loading station,
a multiplicity of holding apparatuses,
at least one unloading station, and

a multiplicity of sorting outputs.

The mail items are fed to the feeder, and the singulator produces a stream of upright mail items which are transported to the loading station.

In the loading station, a respective mail item is automatically pushed into a holding apparatus or put into the holding apparatus in another manner. The holding apparatuses together with the mail items are transported through the sorting installation as far as a respective sorting output.

The reader has a camera and an image evaluation unit. The camera produces a computer-accessible image of the mail item before the mail item is put into the holding apparatus. The image shows the destination identifier on the mail item. The image evaluation unit deciphers the destination identifier while the mail item is transported through the sorting installation.

A selection unit evaluates a prescribed computer-accessible sorting plan and selects a sorting output. The sorting output which the selection unit selects depends on the deciphered destination identifier and on a prescribed computer-accessible sorting plan. The sorting plan allocates a respective sorting output to each possible destination identifier.

After the camera has produced the image of the mail item, the mail item reaches the loading station, and the loading station puts the mail item into the holding apparatus. The mail item is transported in the holding apparatus to the selected sorting output and remains in the holding apparatus at least until the holding apparatus with the mail item reaches the selected sorting output.

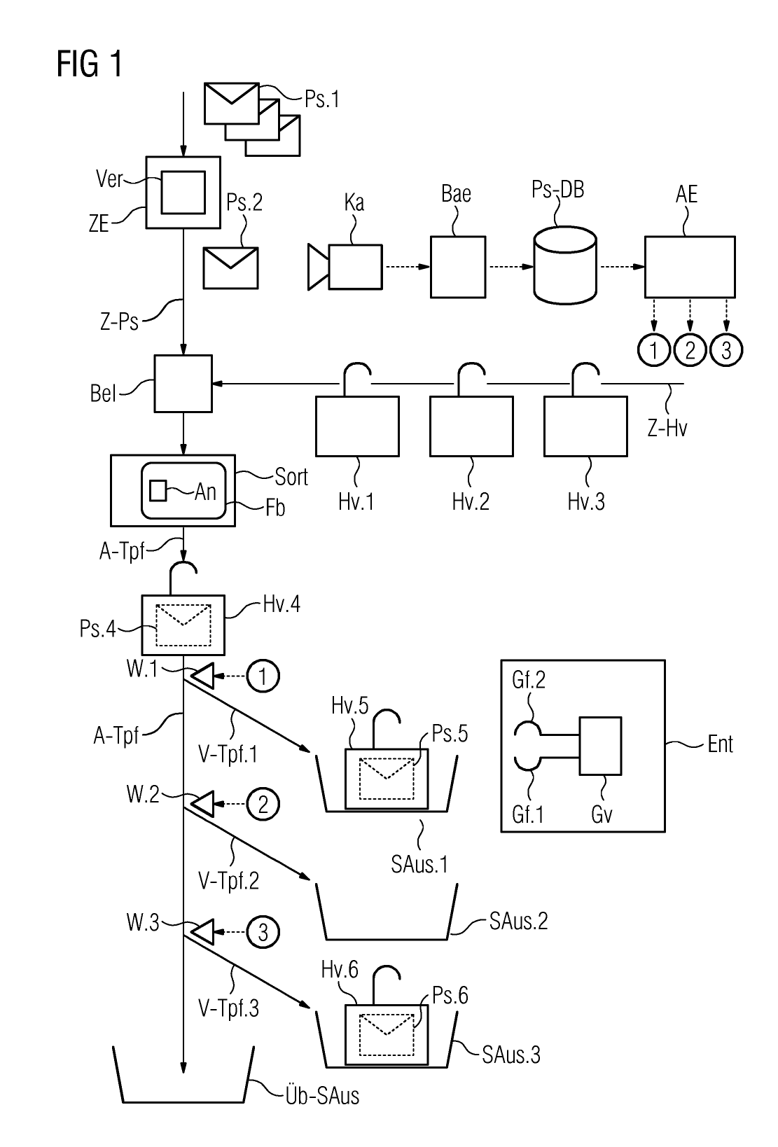

FIG. 1 shows schematically a sorting installation which has the following components:

a feeder ZE with a singulator Ver,
a reader with a camera Ka and an image evaluation unit Bae,
a mail item data store Ps-DB,
a selection unit AE,
a loading station Bel,
an unloading station Ent with a gripping apparatus Gv,
six holding apparatuses Hv.1, . . . , Hv.6,
three sorting outputs SAus.1, SAus.2, SAus.3,
an overflow sorting output Üb-SAus,
a feed transporting path Z-Ps for singulated mail items,
a feed transporting path Z-Hv for empty holding apparatuses,
a sorting and transporting device Sort with a closed conveyor track Fb and a drive
An for holding apparatuses on the closed conveyor track Fb,
an outward transfer transporting path A-Tpf for holding apparatuses which are filled with mail items,
three connecting transporting paths V-Tpf.1, V-Tpf.2, V-Tpf.3 to the three sorting outputs SAus.1, SAus.2, SAus.3, and
three separating filters W.1, W.2, W.3 in the outward transfer transporting path A-Tpf, which are activated by the selection unit AE.

It is also possible for a plurality of loading stations or a plurality of unloading stations to operate in parallel. For example, each sorting output SAus.1, SAus.2, . . . can have a dedicated unloading station with a respective gripping apparatus.

In FIG. 1, material flows are indicated by solid arrows and data flows by dashed arrows.

In addition, six mail items Ps.1, . . . , Ps.6 are shown. The three mail items Ps.4, Ps.5 and Ps.6 have already been placed into the respective holding apparatuses Hv.4 and Hv.5 and Hv.6. The holding apparatus (Hv.4) with the mail item (Ps.4) is just being transported along the outward transfer transporting path (A-Tpf). The holding apparatuses Hv.5, Hv.6 with the mail items Ps.5, Ps.6 have already been put into the sorting outputs SAus.1 and SAus.3, respectively. The holding apparatuses Hv.1, Hv.2, Hv.3 are still empty, and the mail items PS.1, Ps.2, Ps.3 are not yet located in a holding apparatus. The mail item Ps.1 is part of a stack of mail items which have not yet been singulated. The singulated mail item Ps.2 is located in the feed transporting path Z-Ps and upstream of the camera Ka.

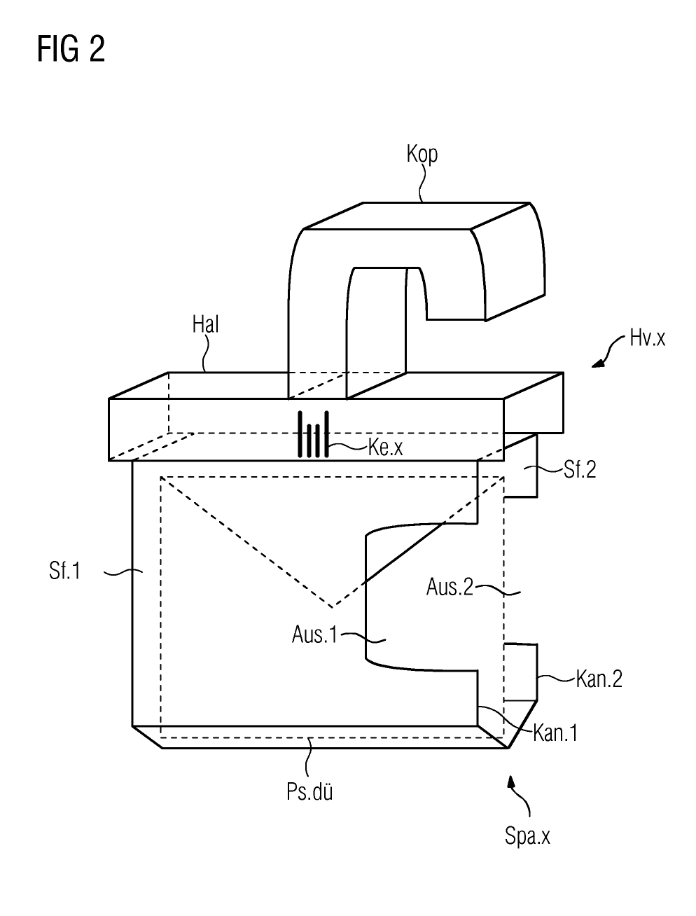

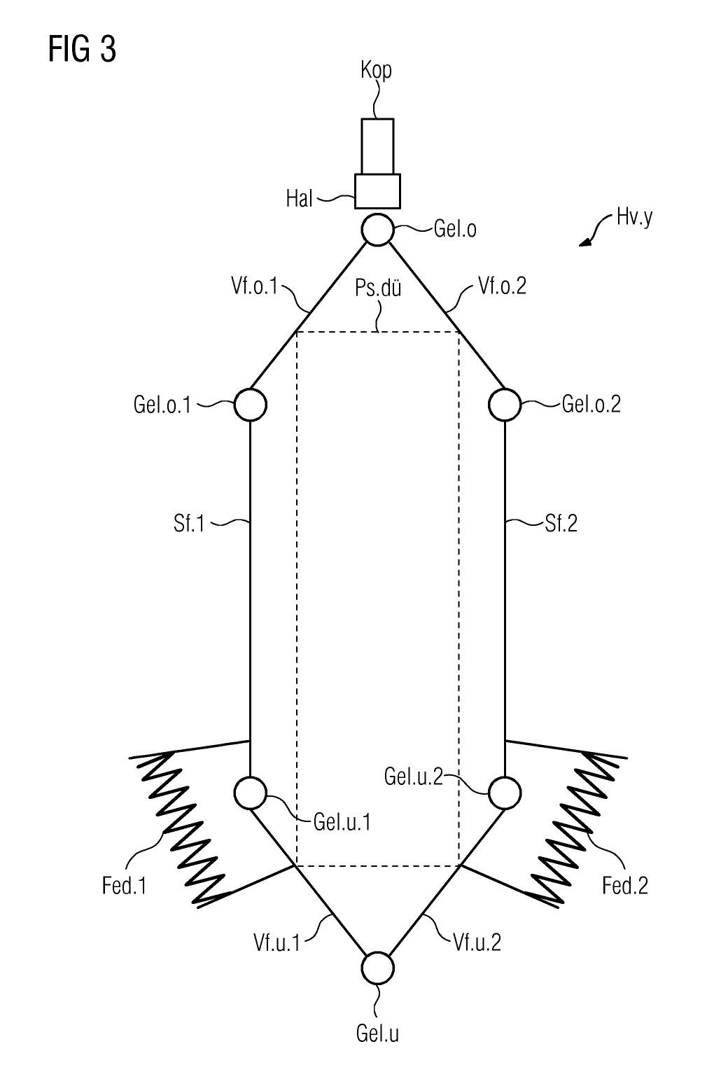

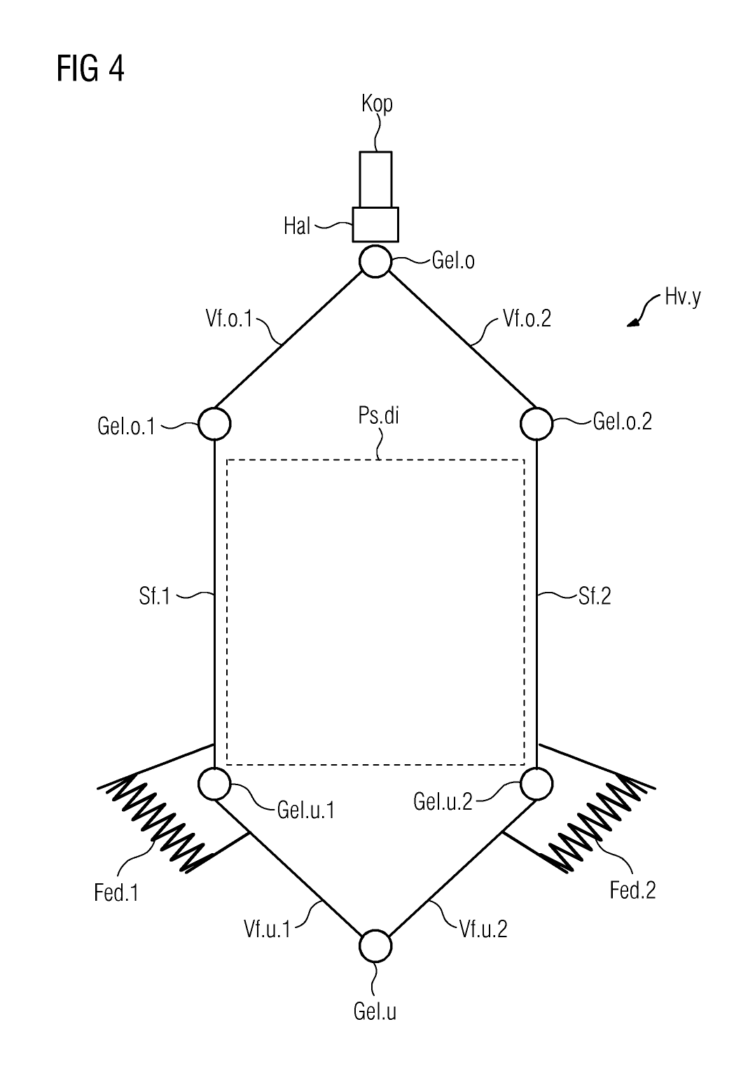

FIG. 2 shows a side view of a holding apparatus Hv.x according to the solution. A cross section through the holding apparatus Hv.y is shown in FIG. 3 and FIG. 4. The side surfaces and the article plane of the mail item Ps.dü and Ps.di lie in the plane of projection of FIG. 2 and are perpendicular to the planes of projection of FIG. 3 and FIG. 4.

The holding apparatuses Hv.x, Hv.y contains:

a centrally mounted coupling element Kop,
a rigid holder Hal,
two side surfaces Sf.1, Sf.2,
an upper connecting element Vf.o with two connecting components Vf.o.1, Vf.o.2,
a lower connecting element Vf.u with two connecting components Vf.u.1, Vf.u.2,
two spring elements Fed.1, Fed.2, and
six articulated connections Gel.o.1, Gel.o.2, Gel.o.3, Gel.u.1, Gel.u.2, Gel.u.3.

A flat mail item can be pushed through the gap Spa.x, Spa.z into the holding apparatus Hv.x, Hv.z and removed again from the holding apparatus Hv.x, Hv.z.

The upper articulated connection Gel.o is fastened to the rigid holder Hal and holds the two connecting components Vf.o.1 and Vf.o.2 of the upper connecting surface Vf.o. The articulated connection Gel.o.1 is located between the side surface Sf.1 and the connecting component Vf.o.1 of the upper connecting element Vf.o. The articulated connection Gel.o.2 is located between the side surface Sf.2 and the connecting component Vf.o.2 of the upper connecting element Vf.o. The articulated connection Gel.u.1 is located between the side surface Sf.1 and the connecting component Vf.u.1 of the lower connecting element Vf.u. The articulated connection Gel.o.2 is located between the side surface Sf.2 and the connecting component Vf.u.2 of the lower connecting surface Vf.u.

In the exemplary embodiment, the two spring elements Fed.1, Fed.2 each have at least one compression spring. In order to compress the compression springs, a force has to be exerted on the spring elements Fed.1, Fed.2. During the expansion, the compression springs endeavor to bring the connecting components Vf.u.1 and Vf.u.2 in line with the side surfaces Sf.1, Sf.2. The distance between the two side surfaces Sf.1, Sf.2 of the holding apparatus Hv.y can be increased counter to the force of the spring elements Fed.1, Fed.2. The spring elements Fed.1, Fed.2 are preferably configured as spiral springs and are let into and integrated in the lower articulated connections Gel.u.1, Gel.u.2. It is also possible likewise to mount a respective spring element on the connecting components Vf.o.1 and Vf.o.2 of the upper connecting component Vf.o, for example, by a compression spring.

FIG. 3 shows the holding apparatus Hv.y in a cross-sectional illustration with a thin mail item Ps.dü. FIG. 4 shows the same holding apparatus Hv.y from the same viewing direction as in FIG. 3 with a thick mail item Ps.di instead of the thin mail item Ps.dü. The thickness of the mail items Ps.dü, Ps.di is illustrated in exaggerated form. The side surfaces Sf.1, Sf.2 are perpendicular to the planes of projection of FIG. 3 and FIG. 4.

In FIG. 4, the spring elements Fed.1, Fed.2 are compressed to a greater extent than in FIG. 3 and exert a greater restoring force on the side surfaces Sf.1, Sf.2. The side surfaces Sf.1, Sf.2 therefore exert a greater force on the thick mail item Ps.di than on the thin mail item Ps.dü. This is expedient because, as a rule, a thick mail item is also heavier than a thin mail item.

As already explained, the loading station Bel puts each mail item Ps.1, Ps.2, . . . into a respective holding apparatus Hv.1, Hv.2, . . . , after the camera Ka has produced an image of that surface of the mail item Ps.1, Ps.2, . . . on which the destination address is placed. The mail item Ps.1, Ps.2, . . . is preferably put into a previously empty holding apparatus Hv.1, Hv.2, . . . , and therefore only one mail item is located in the holding apparatus at each moment, i.e. a holding apparatus does not simultaneously hold two mail items. The mail item is pushed into the space between the two side surfaces Sf.1, Sf.2 and the two connecting elements Vf.o, Vf.u. In the exemplary embodiment, each mail item Ps.1, Ps.2, . . . is pushed from the side into a holding apparatus Hv.x, Hv.y, . . . , specifically either from the side on which the recesses Aus.1, Aus2 are arranged, or from the other side. It is also possible to allow the mail item to slide into a holding apparatus from above.

In one refinement, each holding apparatus is provided with a unique machine-readable identification. This identification is, for example, in the form of a bar pattern (“bar code”) or is stored in a data carrier which can be read contactlessly, the data carrier being connected to the holding apparatus. The unique identification differentiates the holding apparatus from all other holding apparatuses in the sorting installation. The sorting installation has at least one reader for a machine-readable identification of this type on a holding apparatus. The reader is mounted on the outward transfer transporting path and transmits reading results to the selection unit AE.

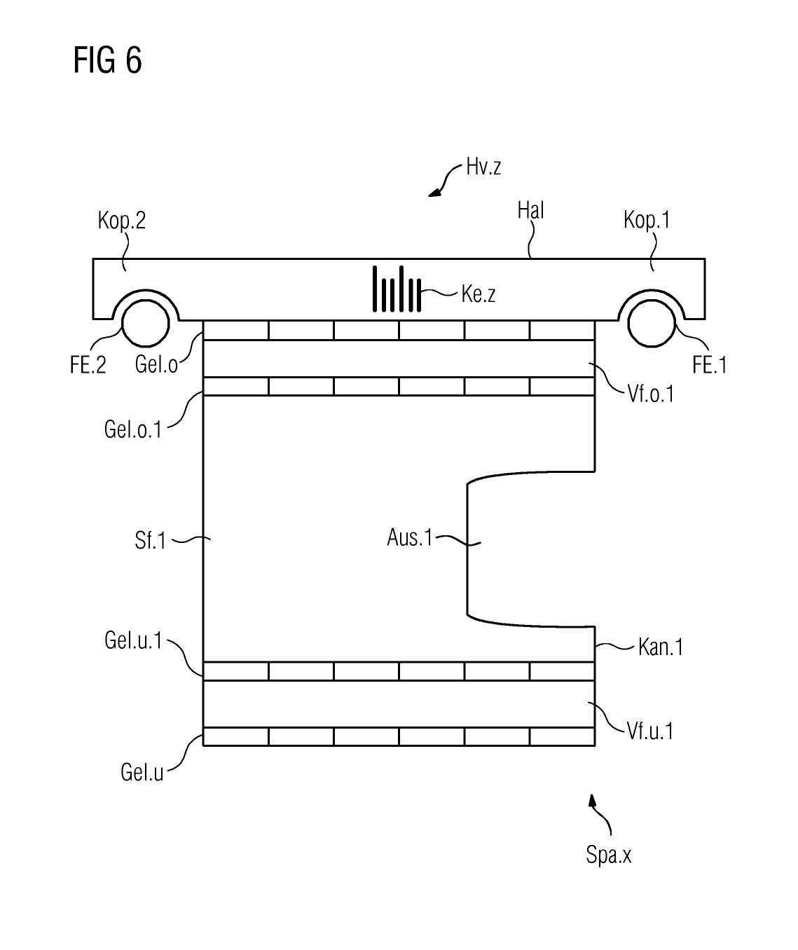

A machine-readable identification Ke.x in the form of a bar pattern is applied to the holder Hal of the holding apparatus Hv.x in FIG. 2. FIG. 6 shows a holding apparatus Hv.x with a machine-readable identification Ke.z.

A respective data set for each mail item is stored in the mail item data store Ps-DB. As soon as a loading station Bel has put a mail item Ps-4 into a holding apparatus Hv-4, the identification of the holding apparatus is read, and the data set for the mail item is supplemented by a coding of the identification of the holding apparatus. This makes it possible to re-read the identification of a holding apparatus later on and, by reading access to the mail item data store Ps-DB and to the sorting plan, to establish which sorting output SAus.1, SAus.2, . . . has been selected in the holding apparatus for the mail item.

The holding apparatuses are configured without a dedicated drive. The sorting and transporting device Sort transports the holding apparatuses Hv.1, Hv.2, . . . with the aid of the central drive An. Each holding apparatus is pulled by a suitable transfer device, e.g. a chain, or moved in another manner and slides in this case in guide rails. The filled holding apparatuses are transported along the closed conveyor track Fb and, when necessary, along further conveyor tracks and, in the process, are sorted depending on the measured sorting feature values of the mail items in the holding apparatuses.

In one refinement, the holding apparatuses are brought into a single sequence. This sequence corresponds to the prescribed order among the occurring sorting feature values.

In one refinement, a plurality of sorting passes are carried out in succession. After the first sorting pass, the holding apparatuses with the mail items are transported back from the sorting outputs SAus.1, SAus.2, . . . back to the feeder ZE and pass again through the sorting installation.

In a deviation, two sorting passes are carried out on two series-connected sorting installations. The mail items in the holding apparatuses pass through the first sorting installation during the first sorting pass, and the first sorting installation distributes the mail items to the sorting outputs. The holding apparatuses with the mail items are transported to the feeder of the second sorting installation. The mail items in the holding apparatuses pass through the second sorting installation in the second sorting pass.

Each mail item remains in the holding apparatus at least until the single sorting pass or the final sorting pass has been completed. The mail items merely need to be singulated before the first sorting pass but not before a subsequent sorting pass. Each mail item therefore passes a single time through the singulator Ver. It is possible for mail items in holding apparatuses to be transported away from the sorting installation with the aid of transporting containers. A previously empty holding apparatus is preferably used in each case for each mail item, therefore only one mail item is located in the holding apparatus. This makes it possible to identify the mail item even in the transporting containers with reference to a machine-readable identification on the holding apparatus.

The mail items are removed from the holding apparatuses after the sorting has been completed or else only at a later time. A flat mail item to be removed is in a vertical position in the holding apparatus and, in the exemplary embodiment, is pulled laterally out of the holding apparatus by a movement of the mail item relative to the holding apparatus. As a result, the holding apparatus is emptied and is capable then of receiving a new mail item.

The holding apparatuses are described in more detail below.

In the exemplary embodiment, each holding apparatus contains two side surfaces which are of identical height, are arranged in parallel and are approximately rectangular. Each side surface extends in a plane. Each flat mail item extends in an article plane. The mail item is held and transported in the holding apparatus in such a manner that the two plane side surfaces and the article planes are all parallel to one another and are arranged approximately vertically. The holding apparatus with the mail item hangs on the coupling element or the coupling elements.

The two side surfaces Sf.1, Sf.2 are connected to each other by at least one connecting element Vf.u which, in one refinement, is connected to the side surface at the respective lower edge of the side surface. The connecting element Vf.u prevents a mail item from dropping downward out of the holding apparatus. The two side surfaces Sf.1, Sf.2 are also connected to each other at other points by connecting elements.

The connecting elements Vf.o, Vf.u are preferably connected to each side surface in an articulated manner. Each connecting element contains two connecting components which are connected to each other in an articulated manner. For example, the articulated connection is realized by a hinge. This refinement makes it possible for each connecting element to be mounted rotatably about an axis of rotation relative to each side surface Sf.1, Sf.2. This in turn has the effect that the distance between the two side surfaces Sf.1, Sf.2 can be changed, and mail items of differing thickness can be put into said holding apparatus.

In another refinement, a connecting element is configured as a single piece and from a single material and has one thin and two thicker points, for example a thin strip. The thin strip divides the planar connecting element into two connecting components on the left and right of the strip. The two connecting components on the left and right of the strip are thicker than the thin strip. Owing to the thin strip, the thicker connecting components can pivot relative to each other, in particular can rotate relative to each other. The thin strip therefore forms a film hinge.

Preferably, at least one resilient element Fed.1, Fed.2 acts on a side surface and on a connecting element connected to the side surface. This refinement has the effect that the distance between the two side surfaces Sf.1, Sf.2 is increased counter to the force of the resilient element or of the resilient elements, and the resilient elements are arranged in such a manner that they reduce the distance. This in turn has the effect that a mail item bears in a planar manner against the two side surfaces, specifically even if mail items of differing thickness are transported in succession in the same holding apparatus. The planar contact and the force of the resilient elements hold the mail item in the holding apparatus and prevent the mail item from sliding out of the holding apparatus. The distance between the side surfaces can be increased only counter to the restoring spring force of the spring element.

It is also possible to produce at least one planar connecting element from a flexible material. The distance between the side surfaces Sf.1, Sf.2 can then also be changed because of said flexibility. However, this does not arise in each case, i.e. there is planar contact between the mail item and the side surfaces Sf.1, Sf.2 for each thickness of a mail item.

In one refinement, the two side surfaces Sf.1, Sf.2 are manufactured from a flexible, preferably elastic material. As a result, the holding apparatus is capable of receiving mail items of differing thickness, wherein a thick mail item bulges the side surfaces Sf.1, Sf.2.

In one refinement, the two elastic side surfaces Sf.1, Sf.2 are configured in such a manner that the two elastic side surfaces—or at least one side surface—are bent or curved in some other way in the rest state. The side surfaces Sf.1, Sf.2 are clamped at the upper and lower edges thereof in a respective elongate, for example rod-shaped, holder Hal. The two side surfaces are clamped concavely in the two holders, i.e. the distance between the upper edges of the side surfaces Sf.1, Sf.2 is greater than the distance at the central height of the side surfaces, and the same applies to the lower edges. A mail item which is pushed laterally between the concave side surfaces Sf.1, Sf.2 pushes the two concave side surfaces apart in the center. The pushed-apart side surfaces exert a counterpressure on the held mail item. The same holding apparatus can be used for mail items of differing thickness. Identical holding apparatuses can transport mail items of differing thickness.

In one refinement, a mail item can be put from above and from one side between the two side surfaces when the two side surfaces are arranged vertically. The other lateral edge of each side surface is closed by a connecting surface between the two side surfaces. The connecting surface connects the two other lateral edges of the side surfaces.

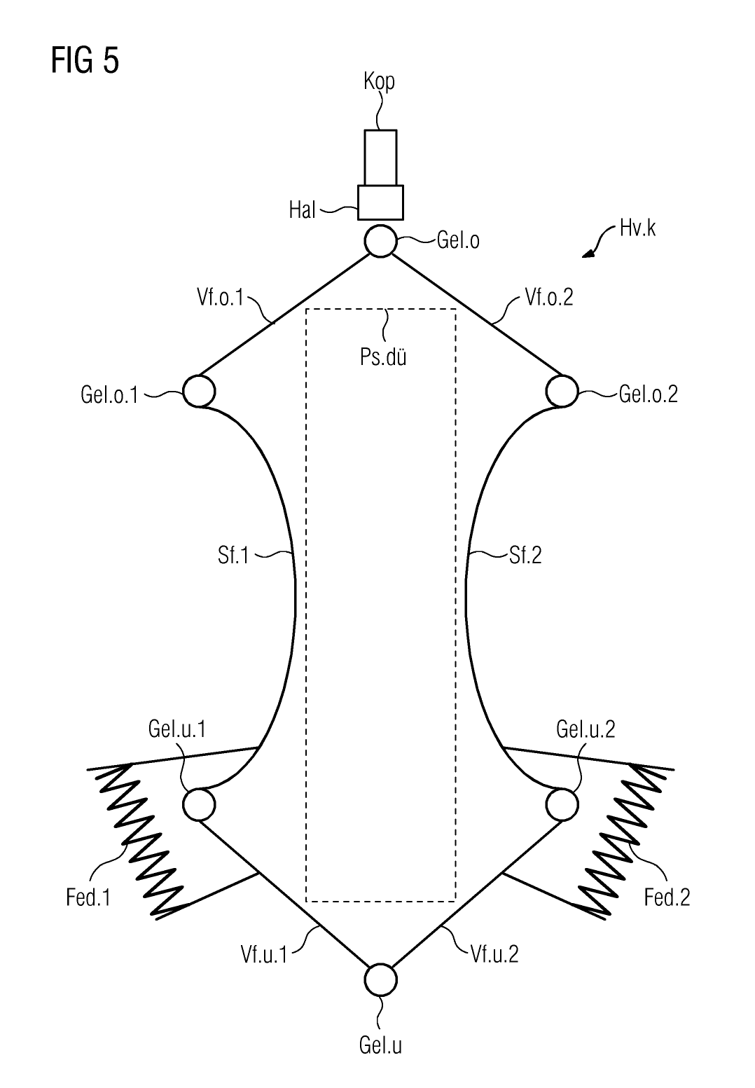

FIG. 5 shows by way of example a holding apparatus Hv.k with two concave side surfaces Sf.1, Sf.2. The side surfaces Sf.1, Sf.2 which are curved concavely inward clamp the mail item Ps.dü between them.

In another refinement, a mail item can be introduced from above and from both sides into the holding apparatus. The two side surfaces Sf.1, Sf.2 are only connected at the lower edges by a planar connecting element and at the side edges only by spot-shaped connecting elements.

In a further refinement, the two side surfaces Sf.1, Sf.2 are connected at their respective upper and lower edges by a respective planar connecting element. This refinement makes it possible to provide the two connecting surfaces with resilient elements. The prestress exerted by the resilient elements results in the side surfaces being pressed onto the mail item and holds the mail item in the holding apparatus.

The holding apparatus hangs on a transporting and guiding device during transportation. The transporting and guiding device contain at least one rod-shaped holder, for example a rail or chain. A coupling element of the holding apparatus engages in the holder. For example, a hook of the coupling element engages around the rail or chain. It is possible for the transporting and guiding device to move the holder and for the moving holder to entrain the coupling element and therefore the holding apparatus with a mail item. For example, the coupling element of the holding apparatus engages in a recess in the moving holder. The coupling element is, for example, in the shape of a hook with a semicircular head.

In one refinement, the holding apparatus has a centrally arranged coupling element on which the holding apparatus hangs while the holding apparatus is transported. FIG. 2 shows a holding apparatus Hv.x with a centrally mounted coupling element Kop.

In another refinement, the holding apparatus has two laterally mounted coupling elements. The transporting and guiding device has two rod-shaped holders. The distance between the two laterally mounted coupling elements of the holding apparatus is matched to the distance between the two rod-shaped holders, and therefore the two coupling elements interact with the two holders, and the holding apparatus rests on the two holders.

FIG. 6 shows a holding apparatus Hv.z with a rigid holder Hal and two laterally mounted coupling elements Kop.1, Kop.2. The two coupling elements Kop.1, Kop.2 are connected to the rigid holder Hal. The side surfaces Sf.1, Sf.2 are arranged parallel to the plane of projection of FIG. 6. The coupling element Kop.1 engages in a guiding device FE.1 which is in the form of a rail. The coupling element Kop.2 engages in a guide element FE.2 which is likewise in the form of a rail.

A combination of the two refinements is also possible, namely by the holding apparatus having a central coupling element Kop and two lateral coupling elements Kop.1, Kop.2. This refinement makes it possible for the holding apparatus to be used either in a transporting and guiding device having a single rod shaped guide or holder or in a transporting and guiding device having two holders.

In the exemplary embodiment, a respective recess is let into the two side surfaces Sf.1, Sf.2 of the holding apparatus. The two recesses in the two side surfaces of a holding apparatus each have a recess region. The recess region may be identical to the entire recess or may only take up part of the recess. The two recess regions preferably correspond with regard to the dimensions thereof, the shape thereof and the position thereof. Each recess begins in a lateral edge of the side surface and tapers away, as seen from the edge. The two recess regions from a continuous opening in the two side surfaces of the holding apparatus. If a mail item is located in the holding apparatus, it is possible to look through the continuous opening.

FIG. 2 shows two congruent recesses Aus.1, Aus.2 in the two side surfaces Sf.1, Sf.2. The two recesses Aus.1, Aus.2 begin at the two lateral edges Kan.1, Kan.2 of the two side surfaces SF.1, Sf.2. In the example in FIG. 2, the two recesses Aus.1, Aus.2 taper inward, i.e. toward the other edge in each case.

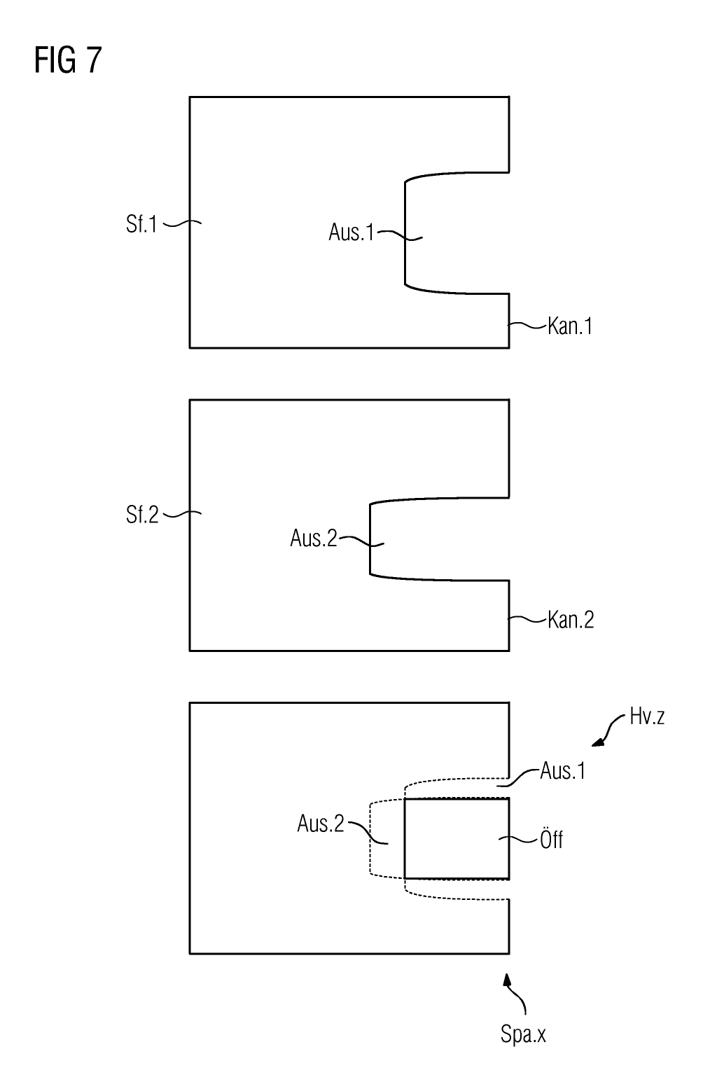

FIG. 7 illustrates the refinement of the holding apparatus Hv.z with a continuous opening Öff. FIG. 7 shows, at the top, the side surface Sf.1 with the recess Aus.1 which begins at the edge Kan.1. FIG. 7 shows, in the center, the side surface Sf.2 with the recess Aus.2 which begins at the edge Kan.2. Both side surfaces Sf.1, Sf.2 are shown from the same viewing direction. The recesses Aus.1, Aus.2 are not congruent. FIG. 7 shows, at the bottom, the holding apparatus Hv.2 from the same viewing direction. It can be seen that the common region of the recesses Aus.1 and Aus.2 forms a continuous opening Öff. A gripping apparatus with two grippers can grip a mail item in the holding apparatus Hv.z through the opening Öff.

The recesses furthermore make it possible to apply a sticker or a stamp or else a mobile data carrier automatically or else manually to a mail item in the holding apparatus, without having to remove the mail item from the holding apparatus, and, as a result, for example, to identify the mail item. The sticker or stamp or data carrier can be applied either to the front side or to the rear side of the mail item. In one refinement, the sticker is applied to the mail item in such a manner that the sticker projects laterally over the side edge of the mail item and also over the lateral edges Kan.1, Kan.2 of the holding apparatus. This makes it possible to mark the beginning or the end of a run of mail items in a sequence of sorted mail items while the mail items are located in respective holding apparatuses. The recesses Aus.1, Aus.2 in the side surfaces Sf.1, Sf.2 also make it easier to grasp the mail items in the holding apparatus from the side and to pull the mail items out of the holding apparatus or else to push the mail items into the holding apparatus.

By the following different refinements which can be combined, a mail item can be prevented from sliding out of the holding apparatus by: elastic side surfaces Sf.1, Sf.2 which are bent outward, i.e. away from each other, by a mail item and hold the mail item by a driving-back force, a sufficiently large coefficient of friction of the inner sides of the side surfaces Sf.1, Sf.2, a respective resilient element between a planar connecting element and a side surface, a planar connecting element which is divided in two in the longitudinal direction, and a hinge with a resilient element as connecting member between the two connecting components of the connecting surface, and clamping in the base edge, the clamping being obtained by a gap in the base edge, wherein the mail item slips under its own weight into the gap and is held by the gap.

In one refinement, the two side surfaces Sf.1, Sf.2 are connected to each other at the upper edges thereof by a connecting surface. In one embodiment, the connecting surface is connected in an articulated manner to the side surface Sf.1, Sf.2. In another refinement, the connecting surface is configured in such a manner that the two side surfaces are connected to each other in a frictional and/or form-fitting manner. For example, the connecting surface is configured in the manner of a thin bar, and each side surface is inserted into a respective slot or other recess in said bar-shaped connecting surface. This refinement makes it possible for transverse forces within the holding apparatus to be dissipated, rather than act on the mail item, when the holding apparatus is transported together with a mail item. The connecting surface is preferably of a strength such that the holding apparatus cannot be buckled or pushed together.

In one refinement, the sorting installation contains at least one unloading station Ent. In the unloading station Ent, the mail items are pulled out of the holding apparatuses. Before the unloading, the holding apparatus holds the mail item between the two side surfaces of the holding apparatus. The side surfaces and the mail items are arranged approximately perpendicularly and parallel to one another.

In the exemplary embodiment, the unloading station Ent contains a gripping apparatus Gv. For unloading purposes, the gripping apparatus Gv grips the mail item through the two recesses. The gripping apparatus has two grippers Gf.1, Gf.2 which are in the form, for example, of rollers or gripper arms. Each gripper Gf.1, Gf.2 reaches through a respective recess in the side surface. The distance between the grippers Gf.1, Gf.2 is reduced until the two grippers bear against the mail item and thereby grasp the mail item between them. The mail item is now moved relative to the holding apparatus.

In one refinement, the mail item is pulled laterally out of the holding apparatus by an approximately horizontal linear movement. In this case, the holding apparatus is preferably held in such a manner that the holding apparatus is not rotated at the same time. If the holding apparatus has two coupling elements, just the lever arm between the two coupling elements prevents undesired rotation. In another refinement, the holding apparatus is rotated or pulled laterally. The gripping apparatus Gv secures the mail item, and the holding apparatus is pulled off from the mail item.

In one refinement, the friction between the two elastic side surfaces Sf.1, Sf.2 and the mail item is additionally reduced by the distance between the upper and the lower edges of the two side surfaces being reduced, i.e. the holding apparatus being compressed. The transverse pressure of the side surfaces on the mail item is reduced as a result.

The sorting installation has a multiplicity of holding apparatuses according to the solution. The holding apparatuses preferably correspond in the following parameters: in the case of two lateral coupling elements, the distance of the coupling elements from each other, the number of connecting elements per holding apparatus, and in the case of a recess in each side surface, the distance of the recess from the lower edge of the side surface.

The invariable distance of the recesses from the respective lower edge makes it easier to align the mail items at the lower edges thereof in the holding apparatuses, for example by the mail items being placed onto a surface in the holding apparatuses and the surface being shaken. The invariable distance between the two coupling elements makes it possible to allow a holding apparatus to be transported by the same transporting and guiding device and to manage with two rails.

The holding apparatuses can differ in the following parameters: height of the side surfaces, and width of the side surfaces.

As a result, the sorting installation is capable of transporting and sorting mail items of differing dimensions.

1. A sorting installation for sorting articles on a basis of a sorting feature, the sorting installation comprising:
at least one loading station;
a measuring instrument configured for the purpose, for each article to be sorted, of measuring what value the sorting feature assumes for the article;
a sorting and transporting device;
a plurality of holding apparatuses each having two mutually parallel side surfaces, at least one of said holding apparatuses configured such that each of said side surfaces having a respective recess formed therein, each said respective recess being adjacent to in each case one edge of said side surface such that said edge being interrupted, and said two side surfaces disposed such that said two recesses each have a recess region, each said recess region begins in a respective said edge of said side surface, and said two recess regions are congruent such that said two recess regions form a continuous opening in said two side surfaces;
an unloading station having a gripping apparatus with a first gripper and a second gripper;
said loading unit configured for putting each of the articles to be sorted into one of said holding apparatuses in each case in such a manner that the article is disposed in a space between said two side surfaces of said holding apparatus, and is held by said holding apparatus;
said sorting and transporting device configured for transporting each of the articles to be sorted in said respective holding apparatus to said unloading station;
said sorting and transporting device configured for sorting said holding apparatuses in accordance with measured sorting feature values of the articles located in said holding apparatuses;
said unloading station removing the article from said holding apparatus by means of said gripping apparatus;
said gripping apparatus being capable of changing a distance between said first and second grippers;
said first gripper capable of gripping one of the articles in said holding apparatus through one said recess region; and
said second gripper capable of gripping the same article through the other said recess region, such that said first and second grippers clamp a grasped article between them through said two recesses.

2. The sorting installation according to claim 1, wherein said gripping apparatus contains a device which limits a force which said first and second grippers exert on the grasped article in said holding apparatus.

3. The sorting installation according to claim 1, wherein a plurality of said holding apparatuses have said two side surfaces in each case, each of said side surfaces have a reference edge, and said recess is let into said two side surfaces of each of said holding apparatuses, and therefore each said holding apparatus having said continuous opening, a distance of each said continuous opening in said holding apparatus from said reference edges of said side surfaces of said holding apparatus being a same for all of said holding apparatuses.

4. A method for sorting articles on a basis of a sorting feature, which comprises the steps of:
providing a sorting installation containing:
at least one loading station;
at least one unloading station;
a plurality of holding apparatuses each having two mutually parallel side surfaces, at least one of said holding apparatuses configured such that a respective recess is let into each side surface of the holding apparatus; and
the unloading station having a gripping apparatus with two grippers including a first gripper and a second gripper;
sorting the articles by the further steps of:
measuring what value the sorting feature assumes for the article;
putting the article into one of the holding apparatuses such that the article is disposed in a space between the two side surfaces of the holding apparatus, and is held by the holding apparatus;
transporting the holding device together with the article to the unloading station;
removing, via the unloading station from the holding apparatus, the unloading station removing the article from the holding apparatus having the two recesses, with the further steps of:
gripping, via the two grippers, the article from two sides through the two recesses in the two side surfaces; and
pulling out a gripped article from the holding apparatus by a relative movement of the two grippers relative to the holding apparatus; and
sorting the holding apparatuses in accordance with measured sorting feature values of the articles disposed in the holding apparatuses.
